(19) United States
(12) Patent Application Publication
(10) Pub. No.: US 2005/0255010 A1
(43) Pub. Date: Nov. 17, 2005

(54) Apparatus and method for automatic preparation of 188 Re-perrhenate solution

(75) Inventors: Ai-Ren Lo, Taipei (TW); Bor-Tsung Hsieh, Taichung City (TW); Tseng-Chung Huang, Jhongli City (TW); Tsai-Yueh Luo, Longtan Township (TW)

Correspondence Address: DENNISON, SCHULTZ, DOUGHERTY & MACDONALD;SUITE 105, 1727 KING STREET, ALEXANDRIA, VA, 22314-2700, US

(73) Assignee: INSTITUTE OF NUCLEAR ENERGY RESEARCH, ATOMIC ENERGY COUNCIL

(21) Appl. No.: 10/846,658

(22) Filed: May 17, 2004

(51) Int. Cl. B32B 5/02

(52) U.S. Cl. 422/159

(57) ABSTRACT

An apparatus includes: a fully automated concentrator for ¹⁸⁸Re-Perrhenate solution, a control box, and a control computer. The concentrator is controlled by the control box which obtains the signals from the computer. The operator can control it from far away, and monitor the processes such as liquid transfer, washing, filtration, collection etc. from a monitor for the computer. The apparatus can measure the radioactive activities of the collected concentrated ¹⁸⁸Re-perrhenate solution and waste during operation; and can also measure the weights of the collecting bottle and solution. Hence the product quality and working efficiency can be increased, and radiation absorbed dose of an operator can be reduced.

### BACKGROUND OF THE INVENTION

1. Field of the Invention

The present invention is related to an apparatus and a method for preparation of ¹⁸⁸Re-perrhenate solution, and especially to an apparatus and a method for preparation of ¹⁸⁸Re-perrhenate solution controlled under set steps, wherein the processes including liquid transfer, washing, filtration, collection etc. of a concentrator are monitored by remote control of a computer during the reaction of concentration. The monitor for the computer displays immediately the activities of the collected concentrated rhenium-188 solution so that the process of concentration can automatically increase the quality of concentration and efficiency of production of the rhenium-188, and can reduce the amount of the radiation absorbed dose of an operator.

2. Description of the Prior Art

The coronary-artery heart disease is a kind of disease most frequently seen in the western industrial countries and have the highest rate of fatality. In the recent years, a tendency has been presenting that the rate of morbidity in Taiwan has been gradually increasing and the ages of patients have been gradually lowering. The rate of morbidity of the patients die because of cardiomyoemphraxis induced by coronary-artery obstruction each year in Taiwan has ranked the third place of the rate of death in Taiwan. The methods of therapy available presently are “balloon dilation”, “laser burning”, “supporting-framework implantation”, “surgical bypassing” and “medical therapy” etc. Wherein the “balloon dilation” is the most often used method by heart physicians; however, according to statistics, 30-50% patients still have the problem of cardiostenosis again after blood-vessel dilation, and the expenses of the therapy are quite high; thereby, to prevent recurring of cardiostenosis is a problem being tried hard to overcome in the medical profession.

The main object of radiation therapy in cooperation with the “balloon dilation” is to solve the problem of fast proliferation of non-striped muscles after the above stated “balloon dilation”, the therapy is first used by a German scientist Dr. Hehrlein in 1993. This method of therapy generally can be divided into two kinds—the radioactive balloon dilation (catheter-based therapy) and the radioactive lead dilation (vascular stents).

Rhenium-188 is a radioisotope having both the function of diagnosis and therapy. The half life period of the parent nuclear species tungsten-188 is 69.4 days, its gamma ray of 155 keV can be applied on image-forming diagnosis or positioning of tumor cells. It is extremely suitable for the radioactive therapy of balloon dilation by the fact that its radiation energy is moderate (β−max=2.12 MeV, γ=155 keV, 15%). The feature of its nuclear species has extremely potential power for therapy of the above mentioned blood-vessel obstruction of heart.

In order to obtain concentrated rhenium-188 solution, The Institute of Nuclear Energy Research-Taiwan was obtained with the material of parent nuclear species (¹⁸⁸W-sodium tungstate solution) from the Oak Ridge National Laboratory of the U.S.A. and successfully built up a tungsten-188/rhenium-188 generator. It took the rhenium-188 solution bred in the generator by rapid vacuum extrusion; ¹⁸⁸Re-perrhenate solution then was obtained by vacuum cleansing with saline solution in the tungsten-188/rhenium-188 generator, and the ¹⁸⁸Re-perrhenate solution was concentrated by the principle of successive tandem-column solid-phase chromatographic method, and then ¹⁸⁸Re-perrhenate adsorbed by anion-exchange resin was dissolved with saline solution, and then cleansed solution was collected in several stages to produce the concentrated rhenium-188 solution meeting the specification of medicine.

Preparation of the above stated concentrated rhenium-188 solution generally uses a semi-automated producing mode which can produce rhenium-188 concentrate with high concentration in a producing process under automatic monitoring and controlling. Such a producing process is a one-way operation. It does not immediately detect the activities of the collected concentrated rhenium-188 solution during the process of concentration for the function of feeding back; and the procedures of zeroing, weighing etc. for a collecting bottle need operation by manpower. During the process, it inevitably has man-made neglect that affects the quality of concentration of products; and during the process of concentrating the ¹⁸⁸Re-perrhenate solution, an operator is unable to completely avoid absorbing radiation. Therefore, the equipment and the producing process for concentration of the ¹⁸⁸Re-perrhenate solution still leave spaces for improvement.

### SUMMARY OF THE INVENTION

The primary object of the present invention is to provide an apparatus for preparation of ¹⁸⁸Re-perrhenate solution that can monitor for remote control with a computer, and can immediately display the reaction process of concentration. (i.e. the process of concentration is automated, the quality of concentration and efficiency of production of the rhenium-188 thus is increased).

The second object of the present invention is to provide an apparatus for preparation of ¹⁸⁸Re-perrhenate solution, wherein all the reactions of concentration of a concentrator are of a sealed mode. When a radioactive nuclear species was loaded into the sealed system for reaction via connection of pipe lines, it goes all the way to the stage of finishing and outputting the last product. Thus the process can avoid leakage of radioactive material and can reduce the amount of the radiation absorbed dose of an operator.

Another object of the present invention is to provide an apparatus for preparation of ¹⁸⁸Re-perrhenate solution, with the apparatus, radioactive activities of the rhenium-188 in a collecting bottle and an waste liquid bottle as well as the weights of the collecting bottle and the collected liquid are measured during the reaction process of concentration for the purpose of monitoring the state of concentration of the rhenium-188, and the reaction is finished according to a command of the computer to refilter and collect the waste liquid.

To achieve the above stated objects, the apparatus for preparation of ¹⁸⁸Re-perrhenate solution of the present invention comprises a concentrator, a control box and a control computer provided with an automatic control program. The concentrator includes at least a container for receiving liquid, a silver cation solid-phase chromatographic tube, an anion-exchange tube, a creeping motor, a plurality of electromagnetic valves, a waste liquid bottle and a collecting bottle. The abovementioned components are mutually connected by means of a plurality of delivery pipes. The collecting bottle is provided thereunder with a weighing element, the waste liquid bottle and the collecting bottle are respectively provided with a set of Geiger tubes. The control box includes an electric power supply, a signal control module, a radiation measuring module and a signal measuring module. The signal control module can cooperate with the control program to control the concentrator to operate in accordance with a given procedure, the radiation measuring module measures the activities of rhenium-188 by means of the Geiger tubes, the signal measuring module can detect the weighing element to measure the weight of the collecting bottle, and the control box of the concentrator is electrically connected with the control computer.

Thereby, the control computer can monitor for remote control, and can immediately display the processes of liquid transfer, washing, filtration, collection etc., and can simultaneously measure the radioactive activities of the rhenium-188 in a collecting bottle and an waste liquid bottle as well as the weights of the collecting bottle and the collected liquid during operation, thereby to increase the quality of concentration and efficiency of production of the rhenium-188, and to reduce the amount of the radiation absorbed dose of an operator.

The method for preparation of ¹⁸⁸Re-perrhenate solution includes the following steps:
step 1: to assemble the collecting bottle and various components of the concentrator, and set zero of the collecting bottle;
step 2: to load solutions such as saline solution and sterilized water etc. respectively in a plurality of containers, to connect the outlet of the bottle, having the ¹⁸⁸Re-perrhenate solution which was eluted from ¹⁸⁸W/¹⁸⁸Re generator with the inlet of the concentrator;
step 3: to control with a computer to start execution of the reaction of concentration of the concentrator;
step 4: to take out the collecting bottle and record the weight of the concentrated solution collected after completion of the reaction of concentration; and to measure the activity of the rhenium-188 in the collecting bottle;
step 5: to change the collecting bottle and to set zero of the new collecting bottle; and then to control with the computer to take samples for recording the weight of the concentrated solution collected, and to measure the activity of the rhenium-188 in the collecting bottle; and
step 6: to control with the computer to wash the pipeline of the concentrator and ion exchange agent with sterilized water for the next reaction.

The present invention will be apparent after reading the detailed description of the preferred embodiment thereof in reference to the accompanying drawings.

### BRIEF DESCRIPTION OF THE DRAWINGS

FIG. 1 is a perspective view showing the appearance of an embodiment of the present invention;

FIG. 2 is a schematic plane view of the embodiment of the present invention;

FIG. 3 is a schematic view showing the path of washing the exchange pipeline of the embodiment of the present invention;

FIG. 4 is a schematic view showing the path of adsorption of rhenium-188 of the embodiment of the present invention;

FIG. 5 is a schematic view showing the path of cleansing, filtering and collecting the rhenium-188 of the embodiment of the present invention;

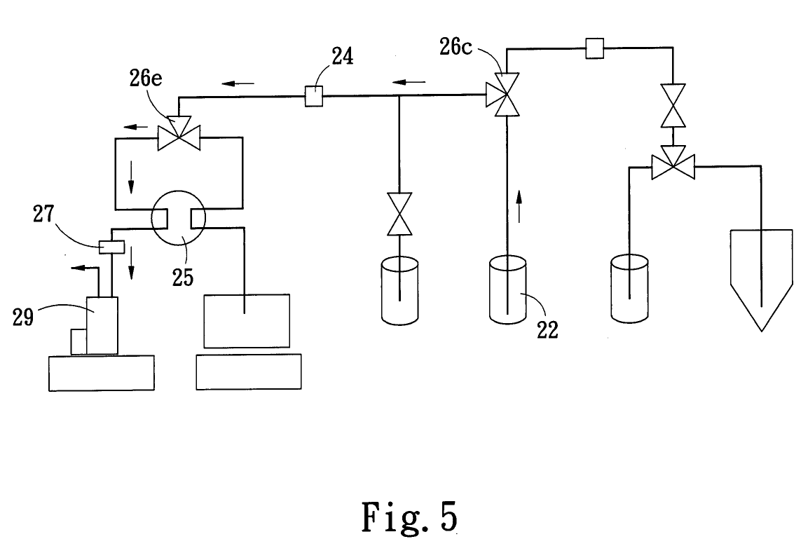

FIG. 6 is a schematic view showing the path of sampling the rhenium-188 of the embodiment of the present invention;

FIG. 7 is a schematic view showing the operating keys on the monitor of the computer for the embodiment of the present invention;

FIG. 8 is a schematic view showing the testing keys on the monitor of the computer for the embodiment of the present invention;

FIG. 9 is a flow chart showing the steps of preparation of the embodiment of the present invention.

### DETAILED DESCRIPTION OF THE PREFERRED EMBODIMENT

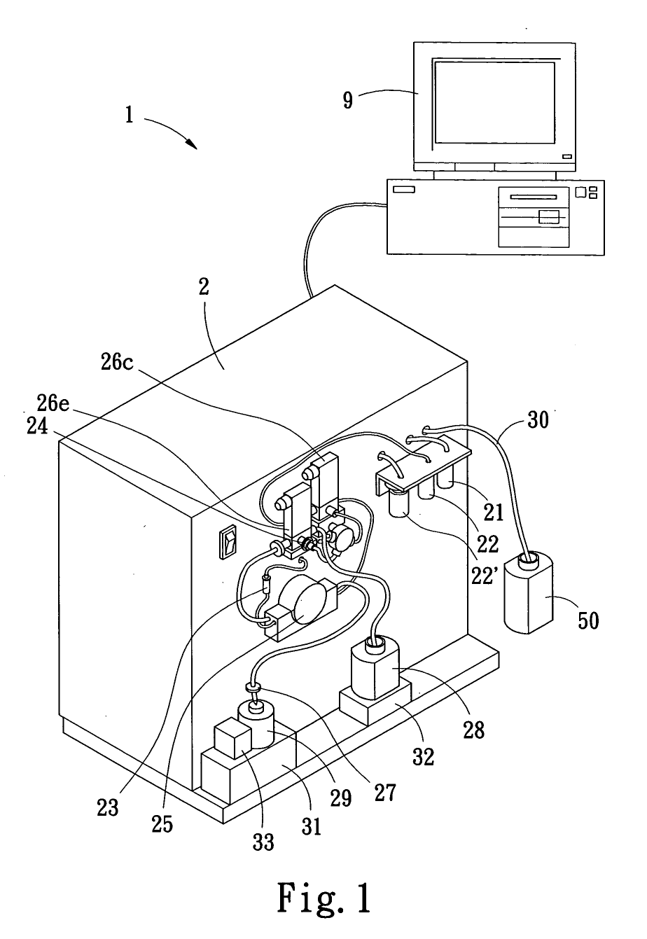

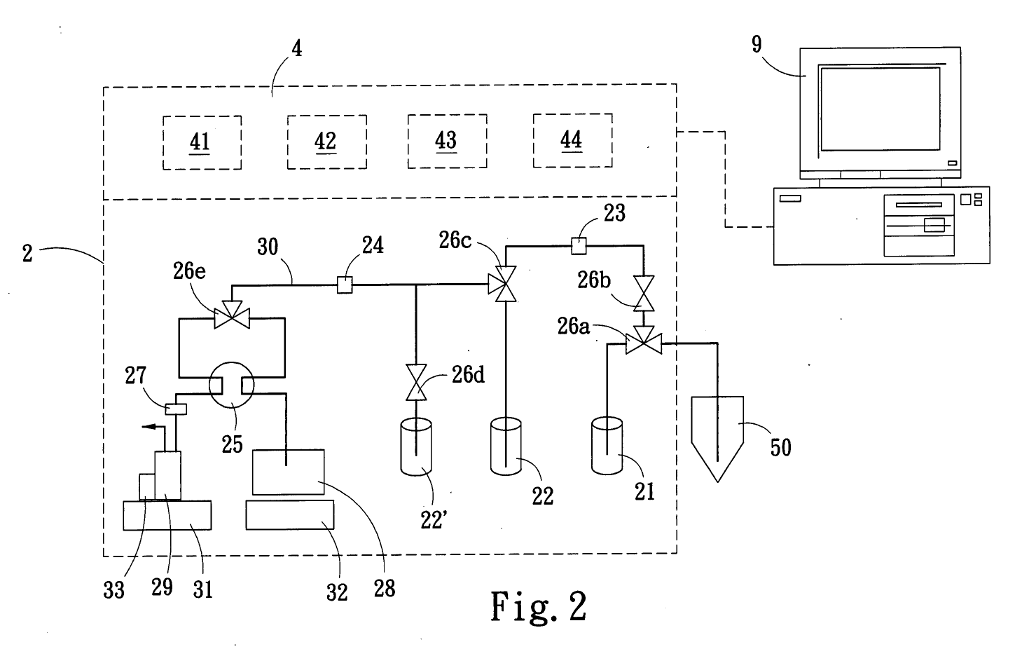

Referring firstly to FIGS. 1 and 2 showing a preferred embodiment of an apparatus 1 for preparation of ¹⁸⁸Re-perrhenate solution of the present invention, the apparatus 1 comprises a concentrator 2, a control box 4 and a control computer 9 provided with an automatic control program.

The concentrator 2 includes a container 21 loaded with 20 cc sterilized water, two containers 22, 22′ loaded with 0.9% saline solutions (the saline solutions loaded therein are respectively 1.2-1.5 cc and 1.0 cc), an IC-Chelate Plus (Alltech) silver cation solid-phase chromatographic tube 23, a Sep Pak anion-exchange tube 24, a creeping motor 25, five electromagnetic valves 26a, 26b, 26c, 26d and 26e, a film 27, a waste liquid bottle 28 and a collecting bottle 29. The abovementioned components are mutually connected by means of a plurality of delivery pipes 30. The collecting bottle 29 is provided thereunder with a weighing element (Load Cell) 31. The waste liquid bottle 28 is provided thereunder with a set of Geiger tubes 32, and the collecting bottle 29 is provided alongside with a set of Geiger tubes 33 so that the activities of the rhenium-188 in the collecting bottle 29 and the waste liquid bottle 28 can be separately monitored; the two sets of Geiger tubes 32, 33 are provided therearound respectively with a lead screen to prevent interference of the external radiation signals.

The control box 4 is provided behind the concentrator 2 to connect with the components of the concentrator 2, and is electrically connected with the control computer 9. The control box 4 includes an electric power supply 41, a signal control module 42, a radiation measuring module 43 and a signal measuring module 44. The electric power supply 41 provides electric power of 24 and 5 volts respectively for the electromagnetic valves 26a, 26b, 26c, 26d, 26e and the signal measuring module 44; the signal control module 42 includes a signal picking card and a digital signal output card (not shown) for cooperating with the control program to control of the concentrator 2 to operate in accordance with a given procedure; the radiation measuring module 43 measures the activities of rhenium-188 by means of the Geiger tubes 32, 33. While the signal measuring module 44 can detect the weighing element 31 to measure the weight of the collecting bottle 29. The weighing element 31 can be controlled by a command of the computer to be set zero.

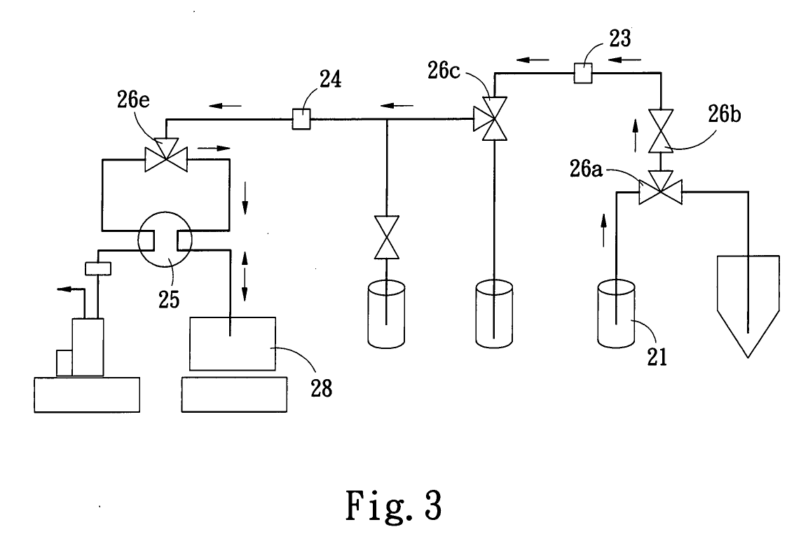

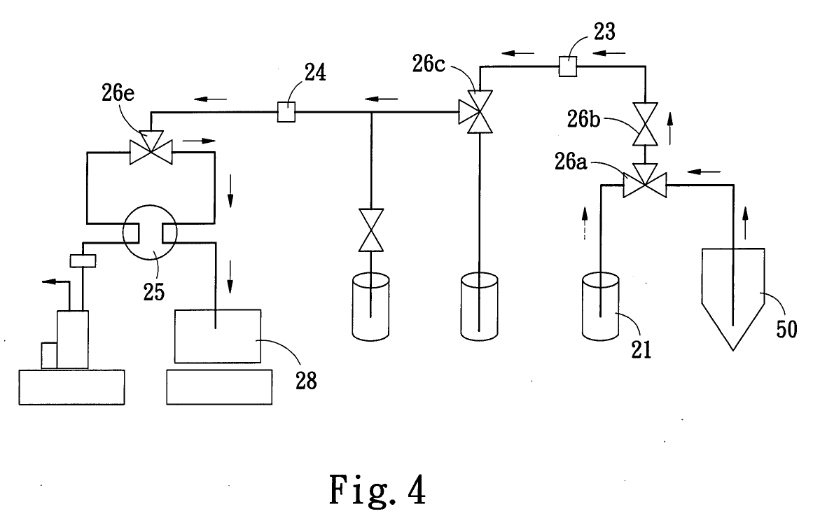

The components of concentrator 2 mentioned above can form a flowing path for the ¹⁸⁸Re-perrhenate solution by connecting with the delivery pipes 30. FIG. 3 shows the flowing path for washing the exchange pipeline before and after the reaction of concentration. Before the process, at least 5 cc sterilized water is used to cleanse the silver cation solid-phase chromatographic tube 23 in advance. During cleansing, the four electromagnetic valves 26a, 26b, 26c and 26e in the flowing path are open, it needs only to actuate the creeping motor 25 to draw the sterilized water from the container 21. The sterilized water flows through the silver cation solid-phase chromatographic tube 23 and the Sep Pak anion-exchange tube 24 and flows into the waste liquid bottle 28. Please refer to FIG. 4 which shows the flowing path of adsorption of rhenium-188 during the process of concentration. The ¹⁸⁸Re-perrhenate solution in a bottle 50 is drawn with the force of the creeping motor 25 and flows through the four electromagnetic valves 26a, 26b, 26c and 26e to complete adsorption in the Sep Pak anion-exchange tube 24. Then the electromagnetic valve 26a is shut down to render the creeping motor 25 to draw the sterilized water from the container 21 to cleanse the Sep Pak anion-exchange tube 24, the liquid flowing out is poured into the waste liquid bottle 28.

Referring to FIG. 4, which shows the flowing path of cleansing, filtering and collecting the rhenium-188 during the process of concentration, in the process, the 1.2-1.5 cc and 1.0 cc 0.9% saline solutions are drawn to wash out the rhenium-188 adsorbed by the anion-exchange tube 24. During operation, the two electromagnetic valves 26c and 26e are opened firstly, and then the creeping motor 25 is actuated, then the concentrated solution flows through the electromagnetic valve 26e and the film 27 (0.22 μm) and is filtered and thereafter is poured into the collecting bottle 29.

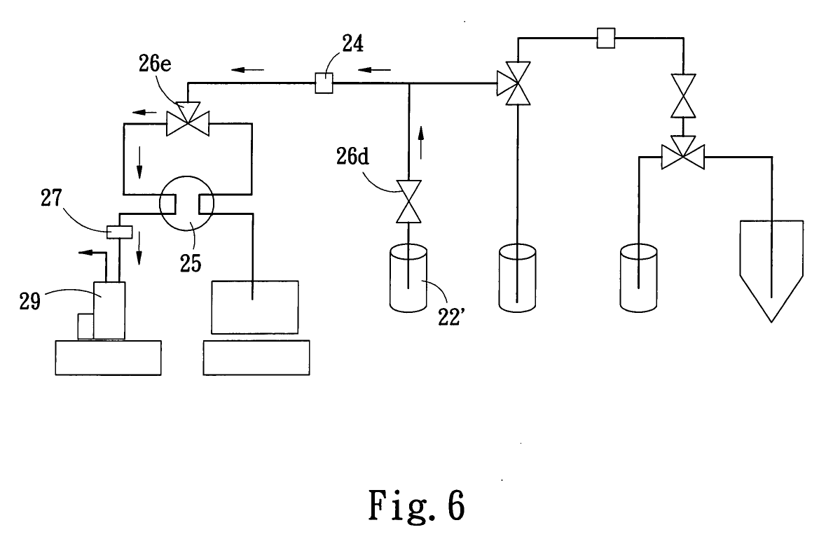

Referring to FIG. 6, after collecting the product in subsequent to the above procedure, the collecting bottle 29 can be removed, and 1.0 cc saline solution is drawn out of the container 22′ to flow through the electromagnetic valve 26d, the anion-exchange tube 24, the electromagnetic valve 26e and the film 27 to wash out the residual rhenium-188 and to pour the latter into another collecting bottle for collection as a sample for analysis. Saline solutions for collection and sampling of the above stated product are respectively loaded in the containers 22, 22′, the saline solutions in the containers 22, 22′ during operation will be completely drawn up.

Various flowing paths used during concentration of the ¹⁸⁸Re-perrhenate solution are controlled by the computer, and form connection by means of various modules of the control box 4; the signal control module 42 of the control box 4 in this embodiment adopted is an FP-RLY-420 of the National Instruments company of the U.S.A.; the radiation measuring module 43 is an FP-AI-502; weighing is done by using the signal measuring module 44 (FP-AI-110 (44)) inputting electric voltage and current, and connection with the computer is built by transmission of the network in cooperation with FP-2000.

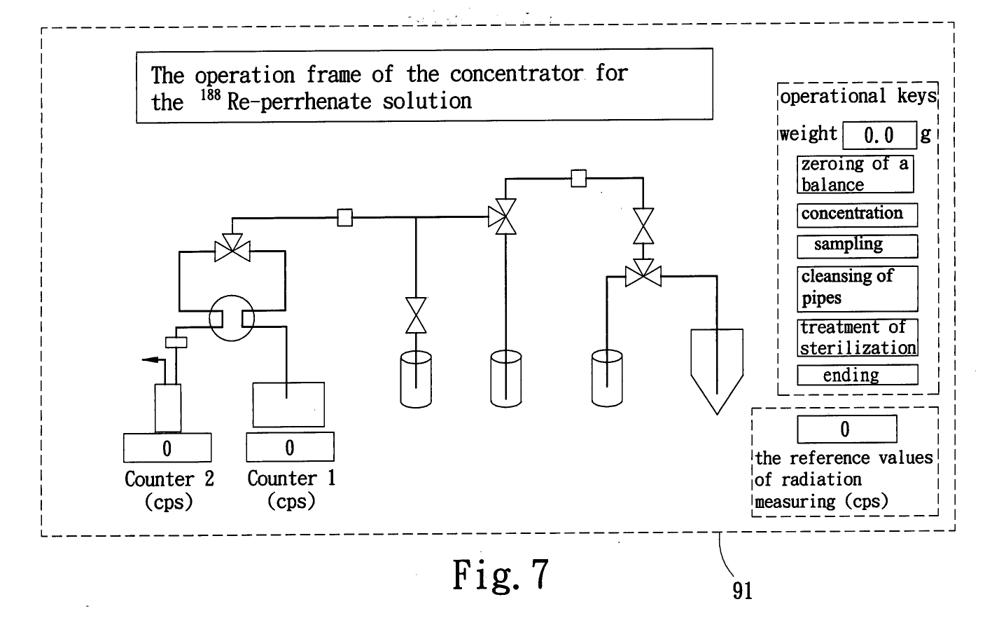

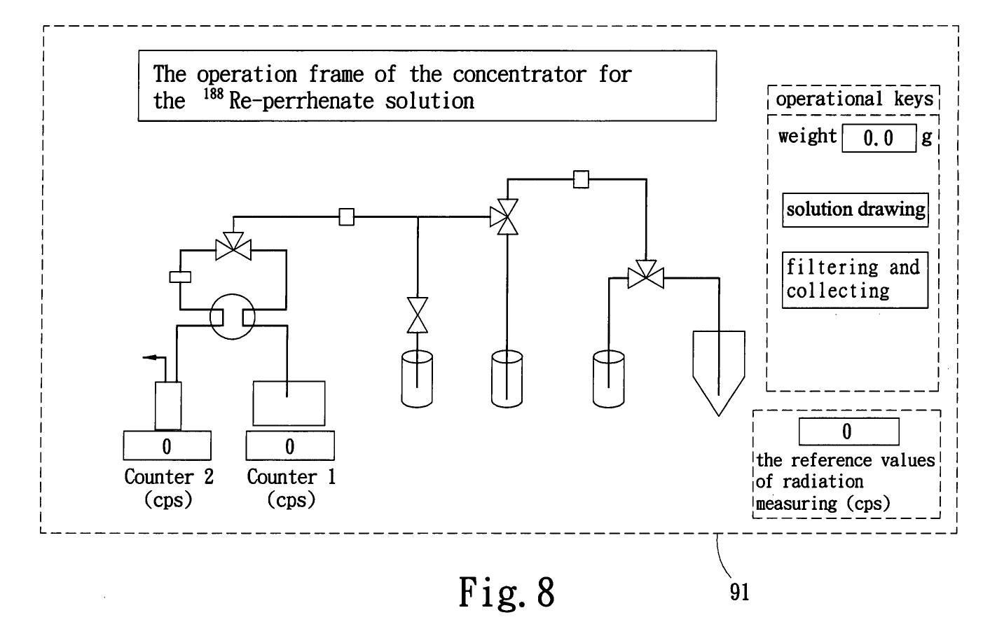

Referring to FIGS. 7 and 8, in connection of the control computer 9 with the control box 4 through the concentrator 2, a monitor 91 thereof can display the operational functions of the concentrator 2, the monitor 91 has two parts including a group of operational keys and a group of testing keys, the operational keys include push buttons for zeroing of a balance, for concentration, sampling, cleansing of pipes, treatment of sterilization and ending etc.; the testing keys include a solution drawing key and a filtering and collecting key. By pressing the push buttons of the above stated operational keys, the concentrator 2 can be controlled to produce the concentrated ¹⁸⁸Re-perrhenate solution under a normal operation work; the testing keys mainly is to actuate the testing function for the concentrator 2 for examining the operation states among components of the concentrator 2 in advance. The reference values of radiation measuring displayed on the monitor 91 can be the bases for automatically examining whether the function of the radiation measuring module 43 is normal.

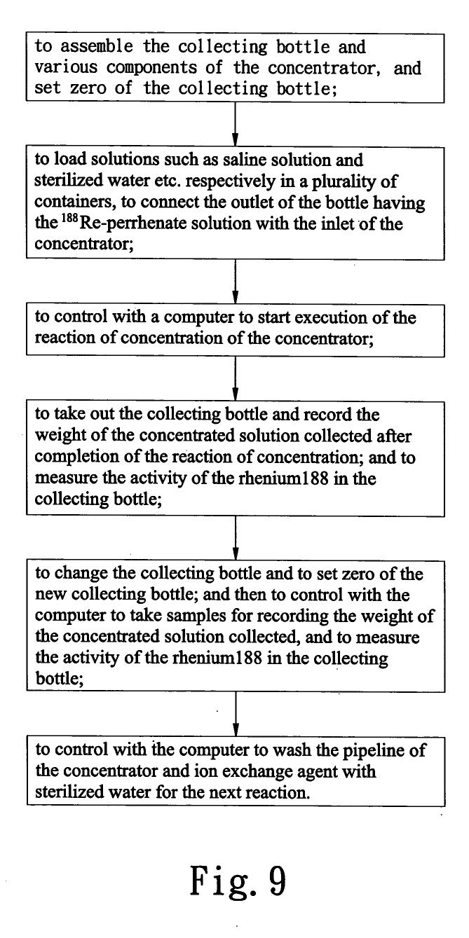

Referring to FIG. 9 showing the flow chart of the method of preparation the ¹⁸⁸Re-perrhenate solution, the method includes the following steps:
step 1: to assemble the collecting bottle 29 and various components of the concentrator 2, and set zero of the collecting bottle 29;
step 2: to load solutions such as saline solution and sterilized water etc. respectively in a plurality of containers (21, 22, 22′), to connect the outlet of the bottle 50 having the ¹⁸⁸Re-perrhenate solution with the inlet of the concentrator 2;
step 3: to shut the door of the lead chamber, and to push down a “concentrating” key on the monitor 91 to render the concentrator 2 to start execution of the reaction of concentration;
step 4: to take out the collecting bottle 29 and record the weight of the concentrated solution collected after completion of the reaction of concentration; and to measure the activity of the rhenium-188 in the collecting bottle 29;
step 5: to change the collecting bottle 29 after completion of the reaction of concentration and to set zero of the new collecting bottle 29; and then to push down the “sampling” key on the monitor 91, record the weight of the concentrated solution collected, and to measure the activity of the rhenium-188 in the collecting bottle 29; and
step 6: to push down the “pipeline cleansing” key on the monitor 91 after completion of the reaction of concentration and sampling, to wash a pipeline 30 of the concentrator 2 and ion exchange agent 23, 24 with sterilized water for the next reaction.

The activity of the rhenium-188 monitored by any set of the Geiger tubes 32, 33 in the above step 4 takes 199000±100 cps as a reference value. When the activity of the waste liquid in the reaction of concentration is higher than the reference value, the “ending” key on the monitor 91 can be pushed down to finish the reaction. Then an empty bottle is used in lieu of the waste liquid bottle 28, the original waste liquid bottle 28 is used as an input terminal. When the solution drawing key of the testing keys is pushed down, adsorption of the rhenium-188 can be completed, and then the filtering and collecting key is pushed down to refilter and recollect solution.

When the concentrator 2 in the embodiment is not used for a long period of time, alcohols of the concentration of 70% loaded in the containers 21, 22, 22′ can be fully filled in the delivery pipes 30 of the apparatus 1 by a “sterilizing” key on the monitor 91 to prevent propagation of germs.

The present invention hence has the following advantages:
1. The present invention can be monitored by remote control of a computer to immediately display the reaction of concentration of a concentrator, the process of concentration can thus be automated; and when the reaction of concentration is inferior, it can be detected immediately, and can be refiltered and recollected to increase the quality and production efficiency of concentration of the rhenium-188.
2. When in operation, the present invention has the concentrator placed in a lead chamber, and all the reactions of concentration are done in sealed modes, this can avoid leakage of radioactive material and can reduce the amount of the radiation absorbed dose of an operator.

In conclusion, according to the description disclosed above, the present invention surely can achieve the expected objects thereof to provide an apparatus and a method for preparation of ¹⁸⁸Re-perrhenate solution able to render the process of concentration to be automated, and to increase the quality of concentration and production efficiency of the rhenium-188 as well as to reduce the amount of the radiation absorbed dose of an operator. Having thus described the technical process of my invention having an extremely high industrial value.

1. An apparatus for preparation of ¹⁸⁸Re-perrhenate solution, said apparatus comprises:
a concentrator including at least a container for receiving liquid, a silver cation solid-phase chromatographic tube, an anion-exchange tube, a creeping motor, a plurality of electromagnetic valves, and a waste liquid bottle and a collecting bottle; these components are mutually connected by means of a plurality of delivery pipes; said collecting bottle is provided thereunder with a weighing element, said waste liquid bottle and said collecting bottle are respectively provided with a set of Geiger tubes;
a control box connecting with said concentrator, said control box includes an electric power supply, a signal control module, a radiation measuring module and a signal measuring module; said signal control module cooperates with a control program to control of said concentrator to operate in accordance with a given procedure, said radiation measuring module measures activities of rhenium-188 by means of said Geiger tubes, said signal measuring module detects said weighing element to measure the weight of said collecting bottle, and
a control computer electrically connected with said control box and provided with an automatic control program;
thereby, said control computer is adapted for monitoring by remote control processes including liquid transfer, washing, filtration, collection etc. of said concentrator during reaction of concentration, and displaying immediately activities of said rhenium-188 in said collecting bottle and said waste liquid bottle as well as said weights of said collecting bottle and collected liquid during operation, thereby to increase quality of concentration and efficiency of production of said rhenium-188, and to reduce the amount of radiation absorbed dose of operators.

2. The apparatus for preparation of ¹⁸⁸Re-perrhenate solution as in claim 1, wherein: one set of said Geiger tubes is mounted beneath said waste liquid bottle, while the other set of said Geiger tubes is mounted at one side of said collecting bottle to monitor immediately said activities of said rhenium-188 in said collecting bottle and said waste liquid bottle.

3. The apparatus for preparation of ¹⁸⁸Re-perrhenate solution as in claim 2, wherein: activity of said rhenium-188 monitored by any set of said Geiger tubes takes 199000±100 cps as a reference value.

4. The apparatus for preparation of ¹⁸⁸Re-perrhenate solution as in claim 1, wherein: said control computer has a testing function for said concentrator for examining operation states among components of said concentrator in advance.

5. The apparatus for preparation of ¹⁸⁸Re-perrhenate solution as in claim 1, wherein: said control computer is adapted to setting zero of a weighing element with a command.

6. The apparatus for preparation of ¹⁸⁸Re-perrhenate solution as in claim 1, wherein: said ¹⁸⁸Re-perrhenate solution flows through a film for filtering and thereafter is poured into said collecting bottle.

7. The apparatus for preparation of ¹⁸⁸Re-perrhenate solution as in claim 1, wherein: said liquids in said at least a container are saline solution and sterilized water.

8. The apparatus for preparation of ¹⁸⁸Re-perrhenate solution as in claim 1, wherein: a monitor of said control computer displays operational functions of said concentrator, said monitor has two parts including a group of operational keys and a group of testing keys, said operational keys include push buttons for zeroing of a balance, for concentration, sampling, cleansing of pipes, treatment of sterilization and ending etc.; said testing keys include a solution drawing key and a filtering and collecting key.

9. A method for preparation of ¹⁸⁸Re-perrhenate solution, said method comprises the following steps:
step 1: to assemble a collecting bottle and various components of a concentrator, and set zero of said collecting bottle;
step 2: to load solutions including saline solution and sterilized water etc. respectively in a plurality of containers, to connect an outlet of a bottle having said ¹⁸⁸Re-perrhenate solution with an inlet of said concentrator;
step 3: to control with a computer to start execution of a reaction of concentration of said concentrator;
step 4: to take out said collecting bottle and record weight of concentrated solution collected after completion of said reaction of concentration; and to measure activity of rhenium-188 in said collecting bottle;
step 5: to change said collecting bottle and to set zero of a new collecting bottle; and then to control with said computer to take samples for recording weight of concentrated solution collected, and to measure activity of rhenium-188 in said new collecting bottle; and
step 6: to control with said computer to wash a pipeline of said concentrator and ion exchange agent with sterilized water for the next reaction.

10. The method for preparation of ¹⁸⁸Re-perrhenate solution as in claim 9, wherein: when activity of waste liquid in said reaction of concentration is overly higher, said control computer is adapted to finishing said reaction of concentration with a command, and to refiltering and recollecting said waste liquid.

11. The method for preparation of ¹⁸⁸Re-perrhenate solution as in claim 9, wherein: when said concentrator is not used for a long period of time, alcohols of the concentration of 70% are fully filled in delivery pipes of said apparatus to prevent propagation of germs.
